(19) United States
(12) Patent Application Publication
(10) Pub. No.: US 2026/0001278 A1
(43) Pub. Date: Jan. 1, 2026

(54) SCAN STRATEGY AND POST-PROCESSING FOR POWER BED FUSION OF UHMWPE

(71) Applicant: VIRGINIA TECH INTELLECTUAL PROPERTIES, INC., Blacksburg, VA (US)

(72) Inventors: Jackson Bryant, Blacksburg, VA (US); Christopher B. Williams, Blacksburg, VA (US)

(21) Appl. No.: 18/878,326

(22) PCT Filed: Jun. 23, 2023
(86) PCT No.: PCT/US2023/068987

§ 371 Date: Dec. 23, 2024

Related U.S. Application Data
(60) Provisional application No. 63/366,984, filed on Jun. 24, 2022.

(51) Int. Cl. B29C 64/386; B29C 64/153; B33Y 50/00; B33Y 70/00

(52) U.S. Cl. CPC B29C 64/386; B29C 64/153; B33Y 50/00; B33Y 70/00

(57) ABSTRACT

Scan strategies and post processing techniques are described for powder bed fusion additive manufacturing workflows using ultra-high molecular weight polyethylene (UHMWPE) powders. In one example, a method for fabricating a part includes generating a three-dimensional model for printing the part, loading the model into a controller of a powder bed fusion tool, generating a scan strategy for individual layers of the part based on the model, where the scan strategy includes a hatch spacing between scan lines in the individual layers, and forming an intermediate part from UHMWPE powder using the tool based on the scan strategy. The method can also include one or more post processing steps, such as heating the intermediate part in an oven at a temperature above the melt temperature of the UHMWPE powder for a period of time in an inert atmosphere, to finish the part.

### CROSS-REFERENCE TO RELATED APPLICATIONS

This application claims the benefit of and priority to U.S. Provisional Patent Application No. 63/366,984, filed Jun. 24, 2022, titled “SCAN STRATEGY AND POST-PROCESSING FOR POWER BED FUSION OF UHMWPE,” the entire contents of which is hereby incorporated herein by reference.

### BACKGROUND

Powder bed fusion (PBF) is an additive manufacturing (AM) technique in which a laser or other source of heat is used to melt and fuse powder materials together. PBF techniques can be used to form three-dimensional (3D) objects. Selective Laser Melting (SLM) or Selective Laser Sintering (SLS) are references to such PBF technologies in which a bed of powder material can be used to create solid objects with a high power-density laser or other source of heat. PBF is a rapid prototyping, 3D printing, or AM technique designed to melt and fuse polymeric and metallic powders together.

A range of different materials can be used to form objects or parts using PBF techniques, including metal and polymer powders or materials. PBF tools can incorporate a number of different heat sources, including laser beams, electron beams, infra-red heaters, and other types of heat sources, and objects can be formed from powder materials fused together based on energy from those heat sources. PBF tools including laser beam heat sources can be categorized as SLS tools, where plastic items or objects can be formed from plastic powder materials, and Direct Metal Laser Sintering (DMLS) tools, where metal items or objects can be formed from metal powder materials.

### SUMMARY

Scan strategies and post processing techniques for powder bed fusion (PBF) additive manufacturing (AM) workflows using ultra-high molecular weight polyethylene (UHMWPE) powder materials are described. In one example, a method for fabricating a part includes loading a model of a part into a controller of a PBF tool, generating, by the controller of the PBF tool, a scan strategy for individual layers of the part based on the model, and forming an intermediate part from UHMWPE powder using the tool based on the scan strategy for the individual layers of the part. The scan strategy can include a hatch spacing between scan lines of an energy source of the PBF tool. The hatch spacing can be larger than a width of the scan lines of the energy source.

In another example, a method for fabricating a part includes generating a model for printing the part, loading the model into a controller of a PBF tool, generating, by the controller for the PBF tool, a scan strategy for individual layers of the model using a hatch spacing among scan lines of the energy source, forming an intermediate part from UHMWPE powder using the tool based on the scan strategy, removing the intermediate part from the tool and excess UHMWPE powder from the intermediate part, and post processing the intermediate part in an oven.

In another example, a method for fabricating a part includes loading a model of a part into a controller of a PBF tool, generating, by the controller of the PBF tool, a scan strategy for individual layers of the part based on the model, where the scan strategy includes a hatch spacing between scan lines of an energy source of the PBF tool in the individual layers, and forming an intermediate part from a powder material using the tool based on the scan strategy for the individual layers of the part.

In other aspects of the embodiments, the methods can include performing one or more post processing steps. The post processing steps can include removing the intermediate part from the tool, removing excess UHMWPE powder from the intermediate part, and processing the intermediate part in an oven. Processing the intermediate part in the oven can include heating the intermediate part at a temperature for a period of time in the oven. For example, processing the intermediate part in the oven can include heating the intermediate part at a temperature above a melt temperature of the UHMWPE powder for a period of time in an atmosphere of Nitrogen.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates an example powder bed fusion tool for use in the fusion of materials according to various aspects of the embodiments described herein.

FIG. 2 illustrates an example part and sectional layers of the part according to various aspects of the embodiments described herein.

FIG. 3 illustrates an example scan strategy for forming the part shown in FIG. 2 from ultra-high molecular weight polyethylene (UHMWPE) materials according to various aspects of the embodiments described herein.

FIG. 4 illustrates an example method for forming parts from UHMWPE materials according to various aspects of the embodiments described herein.

### DETAILED DESCRIPTION

As noted above, powder bed fusion (PBF) is an additive manufacturing (AM) technique in which a laser or other source of heat is used to melt and fuse powder materials together, to form three-dimensional (3D) objects. Selective Laser Melting (SLM) or Selective Laser Sintering (SLS) are references to such PBF technologies in which a bed of powder material can be used to create solid objects with a high power-density laser or other source of heat. PBF is a rapid prototyping, 3D printing, or AM technique designed to melt and fuse plastic and metallic powders together.

Conventional AM workflows using PBF tools have been unsuitable or incapable of printing items or objects with mechanical properties sufficient for end-use applications using certain materials, including ultra-high molecular weight polyethylene (UHMWPE) powder materials and others. Conventional attempts have resulted in parts with little mechanical strength. Particularly, the flexural strength, tensile strength, and relative density of UHMWPE parts formed using conventional techniques have been insufficient for end-use applications.

There are also practical challenges in using UHMWPE as part of PBF AM workflows. When exposed to high-intensity infra-red energy, for example, UHMWPE powders undergo a type of melt explosion, which causes the powder to expand in size (i.e., grow in the z-direction). This expansion causes the printed layer to collide with powder recoating rakes or rollers in PBF tools, resulting in print failures. As a result, prior efforts in printing with UHMWPE powders have been limited to demonstrations of simple geometries. Additionally, the high melt viscosity of UHMWPE powders, coupled with the relatively short time in which the UHMWPE powders remain in the melt-state during processing using PBF tools, prevents the powder particles from flowing and coalescing into dense items, objects, or parts. As such, conventionally printed UHMWPE parts typically have low density and poor mechanical properties.

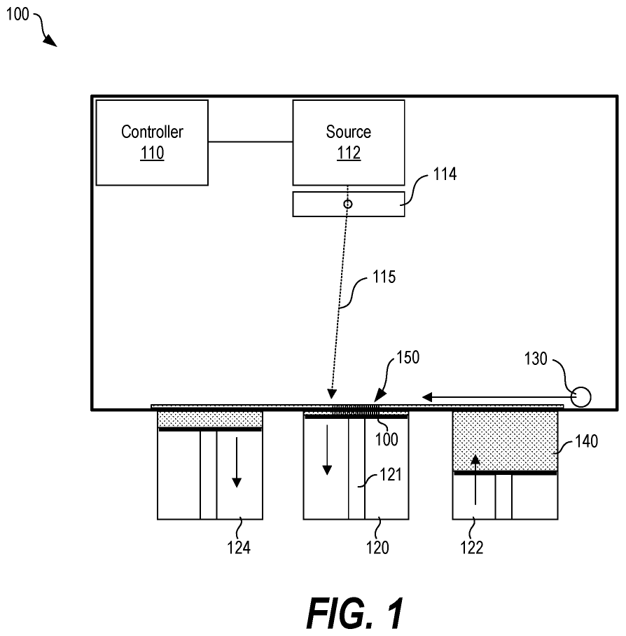

To overcome the problems encountered with conventional approaches, new scan strategies and post processing techniques are described for PBF AM workflows using UHMWPE and other powders. In one example, a method for fabricating a part includes generating a three-dimensional model for printing the part, loading the model into a controller of a powder bed fusion tool, generating a scan strategy for individual layers of the part based on the model, where the scan strategy includes a hatch spacing between scan lines in the individual layers, and forming an intermediate part from UHMWPE powder using the tool based on the scan strategy. The method can also include one or more post processing steps, such as heating the intermediate part in an oven at a temperature above the melt temperature of the UHMWPE powder for a period of time in an inert atmosphere, to finish the part. FIG. 1 illustrates an example PBF tool 100 (“tool 100”) for use in the fusion of materials according to various aspects of the embodiments described herein. The tool 100 is illustrated as a representative example in FIG. 1. A range of tools similar to the tool 100 can be used for the fusion techniques described herein. In one example, the tool 100 is an SLS AM tool, although the methods and embodiments described herein can be applied to other types of PBF tools. Example PBF tools include those manufactured by EOS GmbH, such as the FORMIGA® P 110 Velocis, the EOS P 396, and related tools, those manufactured by Prodways® Group, such as the ProMaker 1000, the ProMaker P2000 HT, and related tools, although other PBF tools are available and can be relied upon. The components of the tool 100 can vary as compared to that shown in FIG. 1. The tool 100 can also include a number of additional parts or components that are not illustrated in FIG. 1.

Among other components, the tool 100 includes a controller 110, a source 112, a source scanner 114, a build chamber 120, a powder source chamber 122, a powder sink chamber 124, and a powder scraper or coating roller 130 (“coating roller 130”). In practice, the relative positions of the build chamber 120, the powder source chamber 122, and the powder sink chamber 124 can vary as compared to that shown in FIG. 1. In some cases, the tool 100 can omit one or more of the build chamber 120, the powder source chamber 122, or the powder sink chamber 124.

The powder source chamber 122 is filled with a powder material 140, which can be fed (e.g., raised or pushed up) into the tool 100 by a feed mechanism in the powder source chamber 122. As the powder material 140 is fed into the tool 100, the rake or recoating roller 130 can push layers of the powder material 140 across the bottom of the tool 100, including over the build chamber 120 and over the powder sink chamber 124. In some cases, the tool 100 can also include a heater, such as a high-intensity infra-red (IR) energy heater, to heat the powder material 140 within the build chamber inside the tool 100 to some extent, to prepare the powder material 140 for fusion by the source 112.

Progressively, the source 112 and the source scanner 114 scan energy 115 across layers of powder material 140 in an area over the build chamber 120. The energy 115 from the source 112 fuses the powder material 140 together, in layers as described herein, to form an item or object 150 in an AM process, in a layer-by-layer process. As individual layers of the item or object 150 are fused together by the energy 115 from the source 112, a mechanism 121 in the build chamber 120 can progressively lower the item or object 150 down into the build chamber 120. In turn, the powder source chamber 122 pushes more powder material 140 into the tool 100 for each layer, the coating roller 130 pushes the additional powder material 140 across the build chamber 120, and excess material is pushed over the powder sink chamber 124. A mechanism in the powder sink chamber 124 lowers or draws the excess material down into the powder sink chamber 124, and the process continues. The tool 100 can be filled with an inert gas to facilitate the formation of the item or object 150, depending upon the characteristics of the powder material 140 and other factors.

In other cases, the tool 100 can omit one or more of the build chamber 120, the powder source chamber 122, or the powder sink chamber 124. In this case, the item or object 150 can be formed without lowering it into the build chamber 120 as each layer is formed. Powder material 140 can be added into the tool 100 for each layer, progressively raising the overall level of the powder material 140 in the tool 100. The coating roller 130 can push additional layers of the powder material 140 over the top of the item or object being formed, as each layer is fused.

The controller 110 can be embodied by any suitable control system, including one or more processors, processing circuits, and memory devices. The controller 110 can be directed, in part, by the execution of software or computer-readable instructions stored on a memory device. Among other operations, the controller 110 is configured to control the source 112 and the source scanner 114, to direct the energy 115 used to fuse the powder material 140 together. The controller 110 can be directed by a three-dimensional (3D) computer-aided design model (e.g., a CAD file) representative of the shape and size of the item or object 150 being formed. One example of such a CAD file is a standard triangle language or a standard tessellation language (STL) file, which is a file type commonly used in 3D printing. An STL file represents a 3D model, which can be sliced into many layers by the controller 110 to be 3D printed by the tool 100. The CAD file can be created or drawn separately using any suitable CAD applications or tools and loaded into the controller 110 via a computer network, removable media drive, or other suitable way.

The controller 110 can define and control a number of operational parameters for PBF AM workflows using the tool 100. For example, the controller 110 can define the feed temperature, the bed temperature, and other temperatures within the tool 100 during AM workflows. The controller 110 can also define the power of the source 112, over time or among scan lines, the number of scans of the source 112 for each layer, the velocity of the scan lines, and other parameters. The controller 110 can also define different power settings of the source 112 for different scan lines (e.g., a different power setting for infill scan lines as compared to contour scan lines), different power settings of the source 112 for different layers of a part, different numbers of scan lines for different layers of a part, different velocities of the scan lines for different layers of a part, and other parameters. The controller 110 can also define other operational aspects of the source 112 and the source scanner 114, including the spacing between scan lines of the energy 115 applied by the source 112. The spacing between a first scan line or sweep of energy applied and a second scan line or sweep of energy applied in a given layer is referred to as the hatch spacing. According to aspects of the embodiments, the controller 110 can be configured to apply or use a hatch spacing that is different from conventional approaches.

Conventional approaches with Nylon powder materials in PBF workflows rely upon overlapping scan lines or sweeps of the energy 115 from the source 112 for a given layer. This overlap was relied upon to ensure that the item or object was solidly fused throughout its volume before it was removed from a PBF tool, as Nylon powder materials have a viscosity that is relatively low. That is, excess Nylon powder materials tend to fall or slide away easily if not fused together when a PBF-formed item is moved.

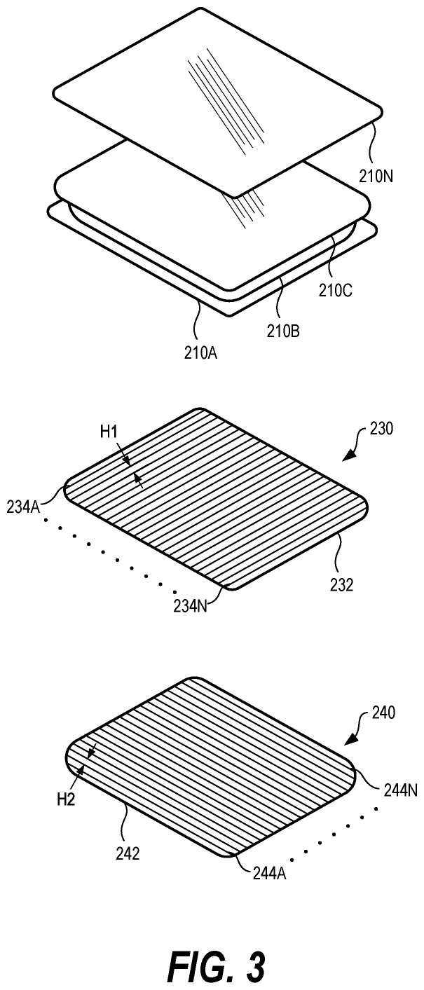

As opposed to the scan line energy overlap used in conventional approaches, larger hatch spacings are relied upon between scan lines according to the embodiments. The controller 110 can be configured to use a hatch spacing that avoids overlapping scan lines or sweeps of the energy 115 from the source 112, in all layers formed. The hatch spacing can be determined based on the powder material 140 used, the width or diameter of the laser or other energy beam generated by the source 112, and other factors. Example hatch spacings are described in further detail below with reference to FIG. 3.

The source 112 can be embodied as any suitable energy or heat source, such as a laser source, electron beam source, an IR energy source or lamp, or other source of heat or energy. The source scanner 114 can be embodied as one or more mirrors or other means capable of directing the heat or energy from the source 112 to an area over the build chamber 120. Both the source 112 and the source scanner 114 can be directed or controlled by the controller 110 to form the item or object 150 based on a CAD file that defines the size, shape, and related aspects of the item or object 150. The width of the laser or other scan energy 115 generated by the source 112 can vary depending on the tool 100, but example widths (e.g., diameters) of the scan energy 115 can range from about 0.2-0.5 mm, although other widths can be relied upon among PBF tools.

Conventional AM workflows have been unsuitable or incapable of printing items or parts with mechanical properties sufficient for end-use applications using certain types of powder materials for many reasons. Conventional attempts have resulted in parts with insufficient mechanical strength, flexural strength, tensile strength, and relative density for end-use applications. For example, a number of problems can occur when attempting to fuse UHMWPE powder materials in PBF tools. The expansion of UHMWPE powder materials during SLS processing techniques has been noted during heating and prior to fusing. The expansion or explosion of UHMWPE powder materials has also been noted during fusing by energy sources. Too much expansion of the UHMWPE powder materials can lead to a mechanical interference between the top layer of items or objects being formed and the coating roller 130 in the tool 100, for example, as layers of items or objects are being formed. Interfering contact between the recoating roller 130 and a fused layer of an item being formed can cause the item to move or shift, leading to misalignments as subsequent layers are formed, defects, and unsuitable AM manufacturing results. The configuration or adjustment of the operating parameters of the tool 100 to account for or overcome these issues has been problematic. Even with post-processing techniques, conventional AM workflows have been unsuitable or incapable of printing items or objects using certain powder materials with suitable mechanical properties.

When exposed to high-intensity infra-red energy, UHMWPE powders undergo a type of melt explosion, which causes the powder to expand in size (i.e., grow in the z-direction measured from the top to the bottom of the page in FIG. 1). This z-growth can cause a printed layer to collide with the coating roller 130, resulting in print failures. As a result, prior efforts in printing with UHMWPE powders have been limited to demonstrations of simple geometries. Additionally, the high melt viscosity of UHMWPE powders, coupled with the relatively short time in which the UHMWPE powders remain in the melt-state during PBF, prevents the powder particles from flowing and coalescing into dense items, objects, or parts. As such, conventionally printed UHMWPE parts typically have low density and poor mechanical properties.

To address the challenges described above, a new AM scan strategy for PBF tools is described herein. The scan strategy can be used to produce parts having complicated geometries using powder materials of relatively high molecular weight, including UHMWPE powder materials. The scan strategy enables the production of complex intermediate parts using UHMWPE and related powder materials. The intermediate parts can be post-processed to attain finished parts having suitable mechanical properties for a range of different applications. Using the scan strategy, layers are made by selectively scanning and coalescing a fraction of each layer using a relatively large scan line hatch spacing, as opposed to the traditional approach where scan lines overlap each other across the entire layer to induce melting and coalescing of all powder particles within the layer. This scanning approach minimizes layer growth or expansion and enables multilayer UHMWPE prints.

According to aspects of the embodiments, the powder material 140 can include a UHMWPE powder material. As one example, the powder material 140 can be the UTEC3041 Ultra High Molecular Weight Polyethylene powder of Braskem®, although other UHMWPE powder materials can be relied upon. The UTEC3041 powder has a melt viscosity that is orders of magnitude greater than Nylon 12 (i.e., PA12), which is a nylon-based powder material commonly used for PBF AM workflows. The UTEC3041 powder melts within the temperature range of 125° C.-135° C. At temperatures above about 400° C., the powder will degrade significantly. PBF AM manufacturing using other high melt viscosity polymers, beyond UTEC3041 powder material, can also be performed using the concepts described herein.

Being classified as a UHMWPE powder material, the powder material 140 can have a relatively high average molecular weight as compared to other powder materials, such as PA12. For example, the powder material 140 can have an average molecular weight within the range of 2.5×10⁶ to 9×10⁶ grams per mole (g/mol), whereas PA12 can have an average molecular weight of about 30,000 g/mol. The scan strategies and processing techniques described herein can be applied to powder materials having relatively large average molecular weights, but the techniques are not limited to use with powder materials having a specific average molecular weight or an average molecular weight larger than a specific value. As examples, the scan strategies and processing techniques described herein can be helpful for the manufacture of parts from powder materials having an average molecular weight of equal to or greater than 1.0×10⁶ g/mol, 1.5×10⁶ g/mol, 2.0×10⁶ g/mol, 2.5×10⁶ g/mol, 3.0×10⁶ g/mol, and 3.5×10⁶ g/mol, and powder materials having other average molecular weights can be relied upon.

In some cases, the powder material 140 can also be obtained through the further refinement of commercially-available powder materials. For example, the average particle size or average particle diameter by mass (D₅₀) of a commercially-available powder material can be specified as 160 μm in size, including particles having sizes ranging from 50 μm and smaller to 300 μm and larger. The powder material 140 used in the tool 100 can be a refined version of such a commercially-available powder material. The particles of the commercially-available powder material can be sorted or separated in size by sieving or screening using one or more mesh filters or screens. In one example, the powder material 140 can include particles of less than or equal to 70 μm in size and smaller. The powder material 140 can include particles of other sizes, however, such as particles of less than or equal to 100 μm, 90 μm, 80 μm, 70 μm, 60 μm, or smaller. In other examples, the powder material 140 can include particles within a size range, such as between 60 μm and 80 μm in size, between 50 μm and 90 μm in size, or between other size ranges.

The scan strategies described herein can be relied upon to reduce the expansion and warpage of UHMWPE powder materials during scanning, as the scan area of each layer is more limited. The concepts also leverage the relatively high viscosity of UHMWPE powder materials to retain the shape of parts being formed with hatch spacings between scan lines during post processing. According to other aspects, the final properties of the items or objects formed can be finished during one or more post processing steps. Overall, the concepts described herein are useful with a wide range of UHMWPE powder materials having higher molecular weights than PA12 powder materials. The strategies make UHMWPE powder materials processable using PBF AM workflows, to manufacture items and objects in which the properties of UHMWPE are needed.

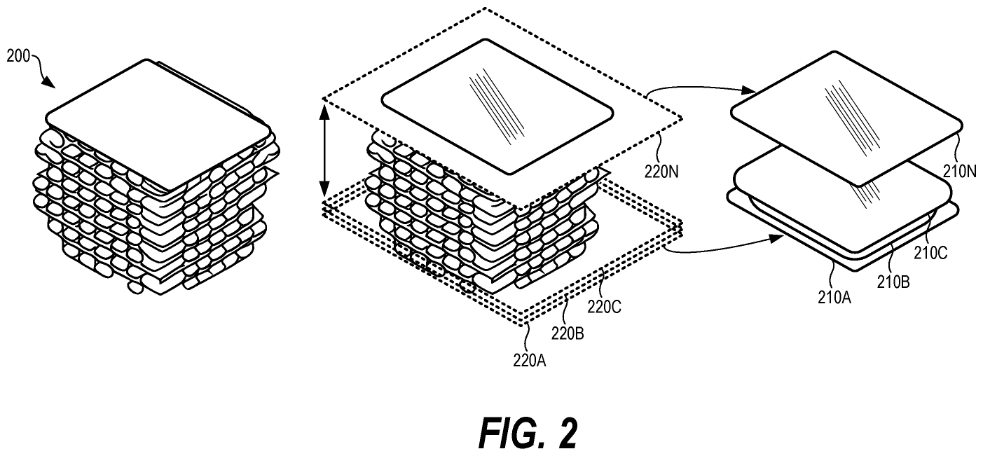

FIG. 2 illustrates an example part 200 and sectional layers 210A-210N of the part 200 according to various aspects of the embodiments described herein. The part 200 is representative in FIG. 2. Thus, the shape, size, and related characteristics of the part 200 are illustrated as a representative example in FIG. 2. The scan strategies described herein can be relied upon to manufacture a range of different parts having sizes, shapes, and other characteristics that vary as compared to the part 200, and the methods described herein are not limited to the manufacture of parts having any particular size or shape.

Each of the sectional layers 210A-210N of the part 200 is representative of a layer of the part 200 that intersects with a respective sectional plane 220A-220N. The sectional layers 210A-210N and sectional planes 220A-220N are also illustrated as examples in FIG. 2. In practice, the part 200 can be segmented or divided into any number of sectional layers (e.g., “N” layers) depending on the type of powder materials used to form the part 200, the size of the part 200, the shape of the part 200, the characteristics of the PBF tool being used (e.g., the type or energy level of the source 112), and other factors.

The part 200 can be represented as a CAD file, such as an STL, standard for the exchange of product (STEP) data, or other format of data file suitable for the representation of a three-dimensional (3D) object or part. The CAD file for the part 200 can be sliced into many layers by the controller 110 to be 3D printed by the tool 100. The CAD file can be created or drawn separately using any suitable CAD applications or tools and loaded into the controller 110 via a computer network, removable media drive, or other suitable way.

FIG. 3 illustrates an example scan strategy for forming the part 200 shown in FIG. 2 from ultra-high molecular weight polyethylene (UHMWPE) materials according to various aspects of the embodiments described herein. The layers 210A-210N of the part 200 are shown at the top of FIG. 3. The layer 210N is representative of a layer of the part 200 that intersects with the sectional plane 220N shown in FIG. 2. The layer 210N of the part 200 can be one layer defined by an STL file of a 3D model of the part 200 to be formed using the tool 100, for example. The layers 210A-210C of the part 200 are other layers defined by an STL file of a 3D model of the part 200 to be formed using the tool 100. The 210A-210C are representative of layers of the part 200 that intersect with the sectional planes 220A-220C shown in FIG. 2, respectively.

The layers 210A-210N of the part 200 can be formed through a new type of scan strategy using the tool 110 according to the embodiments. To implement the scan strategy, the controller 110 of the tool 110 can be configured to have a hatch spacing that avoids overlapping scan lines or sweeps of energy from the source 112, when the layer 210N is formed.

FIG. 3 illustrates an example scan strategy 230 for the layer 210C of the part 200. The scan strategy 230 includes a contour 232 and a number of scan lines 234A-234N. The contour 232 overlaps with and is representative of the outer boundary of the layer 210N, which forms part of the outer peripheral surface of the part 200 being formed through PBF. The scan lines 234A-234N extend through an internal or interior space of the layer 210N and can be referred to as infill scan lines. The scan lines 234A-234N are illustrated as an example in FIG. 3 and additional or fewer scan lines can be relied upon in other cases. Overall, the contour 232 and scan lines 234A-234N are representative of the lines or areas in which energy from the source 112 will be applied to a layer of the powder material 140 in the tool 100 to form the layer 210N of the part 200. As shown, the scan lines 234A-234N do not overlap with each other, with the exception of some intersections between the scan lines 234A-234N and the contour 232. The contour 232 can be omitted in some cases.

To achieve the scan strategy 230, the controller 110 of the tool 100 can be configured to use a hatch spacing “H1” that is greater than the width or diameter of the laser or other energy beam generated by the source 112. For example, the width of the scan beam can be 0.3 mm or less and the hatch spacing “H1” can be 1.2 mm or greater, so that a space of about 0.6-0.9 mm of the powder material 140 in the tool will not be subject to the energy from the source 112 when forming the layer 210C. Thus, the controller 110 can be configured to use a hatch spacing “H1” of four times the width of the scan beam. In other cases, the controller 110 can be configured to use a hatch spacing “H1” of two to five times the width of the scan beam, although other hatch spacings can be used. Other examples of the hatch spacing “H1” include 0.6 mm, 0.7 mm, 0.8 mm, 0.9 mm, 1.0 mm, 1.1 mm, 1.2 mm, 1.3 mm, 1.4 mm, and 1.5 mm, and other hatch spacings can be relied upon.

FIG. 3 also illustrates a scan strategy 240 for the layer 210B of the part 200. The scan strategy 240 includes a contour 242 and a number of scan lines 244A-244N. The contour 242 and scan lines 244A-244N are representative of the lines or areas in which energy from the source 112 will be applied to the powder material 140 in the tool 100 to form the layer 210B. As shown, the scan lines 244A-244N run perpendicular to the scan lines 234A-234N and, from a top-down view, cross the scan lines 234A-234N, but the scan lines 244A-244N do not overlap with each other. The scan lines 244A-244N can also intersect with the contour 242. The contour 242 represents the outer boundary of the layer 210B and forms the outer peripheral surface of the part 200 being formed through PBF. The contour 242 can be omitted in some cases. Alternatively, either the contour 232 or the contour 242 can be omitted, such as the omission of the contour in alternating layers.

The directions of the scan lines 234A-234N and 244A-244N can also be configured by the controller 110 to extend in directions other than that shown in FIG. 3. The scan lines of one layer can run perpendicular to the direction of the scan lines of the next or adjacent layer, although it is not necessary that the scan lines in adjacent layers extend perpendicular to each other. The scan lines can run at angles with respect to each other in some cases.

To achieve the scan strategy 240, the controller 110 of the tool 100 can be configured to use a hatch spacing “H2” that is greater than the width or diameter of the laser or other energy beam generated by the source 112. For example, the width of the scan beam can be 0.3 mm and the hatch spacing can be 1.2 mm, so that a space of about 0.6-0.9 mm of the powder material 140 in the tool will not be subject to the energy from the source 112. Thus, the controller 110 can be configured to use a hatch spacing “H2” of four times the width of the scan beam. In other cases, the controller 110 can be configured to use a hatch spacing “H2” of two to five times the width of the scan beam, although other hatch spacings can be used.

The scan strategies 230 and 240 can be realized by setting the hatch spacings, including the hatch spacings “H1” and “H2,” to a relatively large spacing in the controller 110. The hatch spacings “H1” and “H2” can be the same in some cases. For example, the width of the scan beam can be 0.3 mm and the hatch spacings “H1” and “H2” can each be 1.2 mm, so that a space of about 0.6-0.9 mm of the powder material 140 in the tool will not be subject to the energy from the source 112 when forming the layers 210C and 210B. Thus, the controller 110 can be configured to use hatch spacings “H1” and “H2” of four times the width of the scan beam. In other cases, the controller 110 can be configured to use hatch spacings “H1” and “H2” of two to five times the width of the scan beam, although other hatch spacings can be used. Other example hatch spacings “H1” and “H2” include 0.6 mm, 0.7 mm, 0.8 mm, 0.9 mm, 1.0 mm, 1.1 mm, 1.2 mm, 1.3 mm, 1.4 mm, and 1.5 mm, and other hatch spacings can be relied upon. The hatch spacings “H1” and “H2” can also be different than each other. For example, the hatch spacing “H1” can be 1.2 mm and the hatch spacing “H1” can be 1.0 mm. The controller 110 can be configured to use the same or different hatch spacings for each of the layers 210A-210N of the part 200.

The CAD file that defines the part 200 can also be formed to have spaces that mimic the hatch spacings described above. In that case, the CAD file of the part 200 can be composed of layers of spaced-apart lines of material. The spaced-apart lines of material can mimic the configuration of the controller 110 with a large hatch spacing. With such a 3D model of spaced-apart materials for each layer, a narrower hatch spacing can be used in the tool 100, and the same or a similar result achieved.

When the tool 100 implements the scan strategies 230 and 240, layers of the part 200 are made by selectively scanning and coalescing a fraction of the powder material 140 for the layer using a relatively large scan line hatch spacing, as opposed to the traditional approach where scan lines overlap each other across the entire layer to induce melting and coalescing of all the powder material 140 within the layer. The hatch spacing scanning approach minimizes growth of the powder material 140 in the z-direction in each layer, avoiding mechanical interference between a given layer of the part 200 being formed and the coating roller 130. The selective application of energy from the source 112, with hatch spacings among scan lines, avoids expansion of UHMWPE and related powder materials. Using the scan strategies 230 and 240 for the layers 210C and 210B of the part 200, in addition to similar scan strategies with hatch spacings for the other layers of the part 200, an intermediate or semi-finished part can be completed using the tool 100. The scan strategies enable the production of complex intermediate parts from UHMWPE and related powder materials, which can be post processed to attain the final properties of the parts being manufactured. Parts formed from the tool 100 using the hatch spacing scanning techniques described herein are referred to as intermediate or green parts. Additional process steps can be performed to finish the intermediate or green parts, as described below.

After printing, intermediate parts from the tool 100 can be post processed. The intermediate parts can be removed from the tool 100, and excess powder material 140 can be shaken, brushed, blown, or otherwise removed from the intermediate parts during a clearing step. Referring to the part 200 shown in FIG. 2, for example, the outer surfaces of the part 200 include a number of depressions, indentations, or holes. Excess powder material 140 that is loosely held within such depressions can be cleared or removed from the part 200. The amount of excess powder material 140, if any, will depend on the shape of the part 200, the shape and size of any depressions within the part 200, and other factors. In this context, excess powder material 140 refers to powder material 140 that has not been fused by the energy 115 from the source 112 of the tool 100 during the PBF AM processing steps. Excess powder material 140 can also be contained within the part 200. For example, some amount of excess powder material 140 can be trapped or contained within the contours (e.g., the contours 232 and 242 shown in FIG. 3) of the scan lines used to form the part 200. Excess powder material 140 that is contained within the contours of the scan lines of the part 200 cannot be removed by being shaken or brushed out. This internal powder material can be fused within the part 200 in later steps.

After clearing, intermediate parts from the tool 100 can be post processed in an oven, at temperatures above the melting temperature of the powder material used to form the intermediate parts, to melt and further coalesce the intermediate part together. Intermediate parts can be maintained at this temperature in an inert atmosphere of Nitrogen, Argon, or other inert gas. Experiments have shown that heating intermediate parts formed from UTEC3041 powder in an oven at temperatures of least at 220° C. for two hours in an inert atmosphere of Nitrogen is suitable for post processing the intermediate parts. This allows for molecular motion of the UTEC3041 powder in the intermediate parts, which consolidates and densifies the parts. This densification develops and increases the mechanical properties of the parts into a finished product. Due to the high viscosity of UTEC3041 powder, the intermediate parts retain shape despite being held above melting temperatures during the thermal post process step.

The scan strategies and post processing steps described herein are tailored for polymers with high melt viscosities, such as UHMWPE. During post processing, the intermediate parts further consolidate and densify but do not lose shape. This allows production of final parts with desirable mechanical properties and shape control. Using the combinations of scan strategies and post processing steps, a 3000 kilodalton (kDa) polyethylene powder material was made printable and formed into a final part with suitable mechanical properties for many applications.

In one example test, a number of UHMWPE intermediate parts were printed using UHMWPE powder (D₅₀=71 μm). Powder material was processed on a Prodways® ProMaker P2000 HT with the following processing parameters: infill scan line power=50 W, beam velocity=1000 mm/s, hatch spacing=1.2 mm, scan count=1, contour scan line power=50 W, beam velocity=1000 mm/s, feed temperature=100° C., bed temperature=100° C. The resulting intermediate parts were post processed in an oven under a Nitrogen purge for 2 hours at about 220° C. Before post processing, the intermediate parts were too brittle to be mechanically evaluated. Post processing increased the tensile strength, tensile elongation, and density of the final parts, as shown in Table 1 below.

TABLE 1

| | Density | Tensile strength | Elongation |
|---|---|---|---|
| Sample | (g/cm³) | (MPa) | at break (%) |
| As printed | 0.41 ± 0.01 | Not testable | Not testable |
| 220° C., 2 hours, | 0.52 ± 0.03 | 3.39 ± 0.21 | 66 ± 12 |
| under N₂ | | | |

The post processing technique outlined above is an example. Intermediate parts can be post processed in an oven at other temperatures and for other periods of time. Example temperatures for post processing include temperatures between the melt temperature of the power material used to form the intermediate part but below the temperature at which the mechanical properties of the power material will degrade. Example temperatures for post processing include temperatures between 160° C.-280° C., and other temperatures can be relied upon. Example periods of time for post processing include periods of time between 60 and 180 minutes, and other periods of time can be relied upon. Intermediate parts can also be processed in an oven under pressure of Nitrogen or another inert atmosphere.

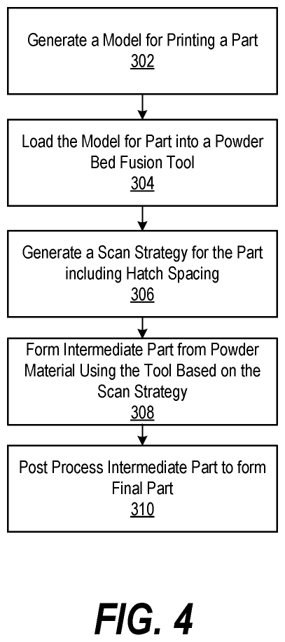

FIG. 4 illustrates an example method for forming parts from UHMWPE materials according to various aspects of the embodiments described herein. FIG. 3 is illustrated as a representative example of certain steps of the method. In some cases, one or more of the steps can be omitted or rearranged as compared to that shown. Additionally, one or more additional steps can be relied upon in the method, although not expressly illustrated in FIG. 4. The process steps below are described with reference to the PBF tool 100 shown in FIG. 1, the part 200 shown in FIG. 2, the scan strategies shown in FIG. 3, and the additional description provided above, but the process steps can be used with other types of PBF, SLS, or SLM tools, other parts, and other scan strategies.

At reference numeral 302, the process includes generating a model for printing an item using a PBF AM tool and workflow. The model can be a 3D model generated using a suitable CAD application, and the model can be representative of the shape and size of the part or item to be printed. The model can be formatted as an STL file, which is a file type commonly used in 3D printing. The STL file can be sliced into many layers for printing by a PBF tool as described herein. The model can be either solid or include voiding to create hatch spacings between scan lines in the individual layers of the model, when printed, as also described herein. As one example, the model can include a 3D model of the part 200 shown in FIG. 2.

At reference numeral 304, the process includes loading the model generated at reference numeral 302 into a PBF tool, such as the tool 100 shown in FIG. 1. For example, the model can be loaded into the controller 110 of the tool 100 via a computer network, removable media drive, or other suitable way.

At reference numeral 306, the process can include generating a scan strategy for the part based on the model. The process can include configuring one or more parameters of the tool 100 to generate the scan strategy. The scan strategy can include the definition or setting of hatch spacings as described herein. The hatch spacings can maintain separation between the scan lines in the individual layers, such that the scan lines do not overlap with each other. As an example, the generation of the scan strategy at reference numeral 306 can include setting a hatch spacing for the layers 210A-210N of the part 200. Thus, reference numeral 306 can include configuring one or more parameters of the tool 100 to implement the scan strategies 230 and 240 shown in FIG. 3, among others.

At reference numeral 306, a hatch spacing can be set or selected for the scan lines 234A-234N of the layer 210C, the scan lines 244A-244N of the layer 210B, and the scan lines for other layers of the part 200. The hatch spacing for the scan lines 234A-234N of the layer 210C can be set or selected to be the same as the hatch spacing for the scan lines 244A-244N of the layer 210B and other layers of the part 200. In another example, the hatch spacing for the scan lines 234A-234N of the layer 210C can be set or selected to be different than the hatch spacing for the scan lines 244A-244N of the layer 210B and other layers of the part 200.

The generation of the scan strategy at reference numeral 306 can also include configuring other parameters of the tool 100. For example, reference numeral 306 can also include defining the feed temperature, the bed temperature, and other temperatures to be used during the workflow of the tool 100 to generate the part 200. The generation of the scan strategy can also include defining the power of the source 112, over time or among scan lines, the number of scans of the source 112 for each layer 210A-210N of the part 200, the velocity of the scan lines, and other parameters. Different power settings of the source 112 can be defined for different scan lines (e.g., a different power setting for infill scan lines as compared to contour scan lines), different power settings of the source 112 for different layers 210A-210N of the part 200, different numbers of scan lines for different layers 210A-210N of the part 200, different velocities of the scan lines for different layers 210A-210N of the part 200, and other parameters.

At reference numeral 308, the process includes forming an intermediate part from UHMWPE powder using the tool 100 based on the scan strategies for the individual layers of the model generated at reference numeral 306. As an example, the source 112 and the source scanner 114 of the tool 100 can scan energy across layers of the powder material 140 in an area over the build chamber 120. The energy from the source 112 fuses the powder material 140 together, in layers as described herein, to form an item or object 150 in an AM process, in a layer-by-layer process.

At reference numeral 310, the process includes post processing the intermediate part. The post processing can include removing the intermediate part from the tool 100 and removing excess powder material 140 from the intermediate part. Excess powder can be removed by shaking, lightly disturbing, blowing, or brushing the intermediate part, as or after it is removed from the tool 100.

The post processing at reference numeral 310 can also include one or more steps of heating the intermediate part in an oven. The post processing can be relied upon to further densify the intermediate part into a finished part. For example, the intermediate part can be heated in an oven at a temperature above the melt temperature of the powder material 140 for a period of time in an inert atmosphere, such as an atmosphere of Nitrogen, Argon, or other inert gas. The inert atmosphere can help to ensure that the intermediate part does not degrade when heated, such as due to degradation in the presence of Oxygen, which can degrade UHMWPE materials, particularly in the presence of Oxygen when heated. The inert atmosphere can be a pressurized atmosphere, such as a pressurized atmosphere of between 1500-3000 psi or higher in some cases.

The temperature of the oven can be greater than the melt point of the powder material 140. In the case of UTEC3041 powder, which melts within the temperature range of 125° C.-135° C., the post processing can include heating the intermediate part in an oven at a temperature of at 220° C. for two hours in an atmosphere of Nitrogen, although other temperatures, periods of time, and gases can be used. In some cases, the post processing can include a first step of heating the intermediate part in an oven at a first temperature for a first period of time, such as at 220° C. for two hours, followed by a second step of heating the intermediate part in an oven at a second temperature for a second period of time, such as at a higher or lower temperature for a longer or shorter period of time. In any case, the temperatures used in the post processing steps should be maintained under any temperatures that would cause the powder material 140 to degrade, such as by losing shape or form. Temperatures of greater than 400° C. can cause certain UHMWPE powders to degrade and should be preferably avoided.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims. If a component is described as having “one or more” of the component, it is understood that the component can be referred to as “at least one” component.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

The flowchart of FIG. 4 the functionality and operation of an implementation of portions of an application executed by processing circuitry or at least one hardware processor, such as in the tool 100. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor (e.g., a hardware processor) in a computer system or other system. The machine code may be converted from the source code, etc. If embodied in hardware, each block may represent a circuit or a number of interconnected circuits to implement the specified logical function(s).

Although the flowchart of FIG. 4 shows a specific order of execution, it is understood that the order of execution may differ from that which is depicted. For example, the order of execution of two or more blocks may be scrambled relative to the order shown. Also, two or more blocks shown in succession in FIG. 4 may be executed concurrently or with partial concurrence. Further, in some embodiments, one or more of the blocks shown in FIG. 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method for fabricating a part, comprising:
loading a model of a part into a controller of a powder bed fusion (PBF) tool, the PBF tool comprising an energy source;
generating, by the controller of the PBF tool, a scan strategy for individual layers of the part based on the model, the scan strategy comprising a hatch spacing between scan lines of the energy source in the individual layers; and
forming an intermediate part from ultra-high molecular weight polyethylene (UHMWPE) powder using the tool based on the scan strategy for the individual layers of the part.

2. The method according to claim 1, wherein the hatch spacing is larger than a width of the scan lines of the energy source.

3. The method according to claim 1, wherein:
a width of the scan lines of the energy source is equal to or less than 0.3 mm; and
the hatch spacing is between 0.6 mm and 1.5 mm.

4. The method according to claim 1, wherein:
the model comprises a solid model of the part; and
the hatch spacing is defined by the controller to be larger than a width of the scan lines of the energy source.

5. The method according to claim 1, wherein the model comprises voiding to create the hatch spacing between the scan lines in the individual layers.

6. The method according to claim 1, further comprising performing at least one post processing step on the intermediate part to form the part.

7. The method according to claim 6, wherein performing the at least one post processing step comprises:
removing the intermediate part from the tool;
removing excess UHMWPE powder from the intermediate part; and
processing the intermediate part in an oven.

8. The method according to claim 7, wherein processing the intermediate part in the oven comprises heating the intermediate part at a temperature for a period of time in the oven.

9. The method according to claim 7, wherein processing the intermediate part in the oven comprises heating the intermediate part at a temperature above a melt temperature of the UHMWPE powder for a period of time in an atmosphere of Nitrogen.

10. The method according to claim 7, wherein processing the intermediate part in the oven comprises heating the intermediate part in an oven at a temperature of about 220° C. for about two hours in an atmosphere of Nitrogen.

11. A method for fabricating a part, comprising:
generating a model for printing the part;
loading the model into a controller of a powder bed fusion (PBF) tool, the PBF tool comprising an energy source;
generating, by the controller for the PBF tool, a scan strategy for individual layers of the model using a hatch spacing among scan lines of the energy source;
forming an intermediate part from ultra-high molecular weight polyethylene (UHMWPE) powder using the tool based on the scan strategy;
removing the intermediate part from the tool and excess UHMWPE powder from the intermediate part; and
post processing the intermediate part in an oven.

12. The method according to claim 11, wherein the hatch spacing is larger than a width of the scan lines of the energy source.

13. The method according to claim 11, wherein:
a width of the scan lines of the energy source is equal to or less than 0.3 mm; and
the hatch spacing is between 0.6 mm and 1.5 mm.

14. The method according to claim 11, wherein post processing the intermediate part in the oven comprises heating the intermediate part in the oven at a temperature of about 220° C. for about two hours in an atmosphere of Nitrogen.

15. A method for fabricating a part, comprising:
loading a model of a part into a controller of a powder bed fusion (PBF) tool, the PBF tool comprising an energy source;
generating, by the controller of the PBF tool, a scan strategy for individual layers of the part based on the model, the scan strategy comprising a hatch spacing between scan lines of the energy source in the individual layers; and
forming an intermediate part from a powder material using the tool based on the scan strategy for the individual layers of the part.

16. The method according to claim 15, wherein the powder material comprises an ultra-high molecular weight polyethylene (UHMWPE) powder.

17. The method according to claim 15, wherein the hatch spacing is larger than a width of the scan lines of the energy source.

18. The method according to claim 15, wherein:
a width of the scan lines of the energy source is equal to or less than 0.3 mm; and
the hatch spacing is between 0.6 mm and 1.5 mm.

19. The method according to claim 15, further comprising performing at least one post processing step on the intermediate part to form the part.

20. The method according to claim 19, wherein performing the at least one post processing step comprises:
removing the intermediate part from the tool;
removing excess powder material from the intermediate part; and
processing the intermediate part in an oven.
